(19) United States
(12) Patent Application Publication
(10) Pub. No.: US 2015/0202561 A1
(43) Pub. Date: Jul. 23, 2015

(54) AIR FILTER WITH FOLDED PLEATS

(71) Applicant: BHA Altair, LLC, Franklin, TN (US)

(72) Inventors: Rex Allen Morgan, Greenville, SC (US); Sanji Ekanayake, Atlanta, GA (US)

(21) Appl. No.: 14/159,470

(22) Filed: Jan. 21, 2014

(51) Int. Cl. B01D 46/52

(52) U.S. Cl. CPC B01D 46/522

(57) ABSTRACT

An air filter includes a filter material having a plurality of pleats, where each of the pleats includes a primary section and a folded section. The folded section is initially folded over at least a portion of the primary section such that the pleat has an initial pleat height. The folded section is configured to unfurl from being folded over the primary section based on a pressure differential between opposite sides of the filter material.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The invention relates generally to air filtration and, more specifically, to an air filter including pleats with folded sections that facilitate maintaining a constant pressure drop while extending the life of the filter.

Air entering a turbine compressor inlet and similar devices should be filtered before compression or other use. Impure inlet air laden with dirt, debris, dust particles, salt, and other contaminants may damage the compressor blades, plug cooling passages, and damage other types of power generation equipment via corrosion, erosion, fouling, and the like. Such damage may reduce the life expectancy and the overall performance of the power generation equipment. To avoid this problem, the inlet air may pass through one or more filters to remove the contaminants.

Air filters, however, may have a relatively short life span due to accumulation of the dirt, debris, and other types of contaminants. This accumulation also may raise the pressure drop across the filter element. Raising the pressure drop reduces the overall power output and the efficiency of the gas turbine engine. As such, the filter elements typically may be replaced when the pressure drop reaches the point in which the gas turbine operator deems the loss of machine efficiency exceeds the costs of the replacing the filters. Many gas turbine engines may have automatic controls that signal when the filters have reached a predetermined set point and filter replacement is needed. If the operator does not replace the filters at the alarm point, additional controls may shut the gas turbine engine down to prevent inlet or filter implosion due to high filter element pressure drops. The gas turbine engine typically may be shutdown for the replacement of the filters.

Frequent filter replacement thus may result in high maintenance costs to the gas turbine end user in terms of labor and filters as well as the loss of revenue due to engine downtime and unavailability. Likewise, online replacement of the filters may result in premature wear of the gas turbine internal components.

To date, known self-cleaning inlet air filter elements have relied on a reverse blast of compressed air that creates a shock wave which knocks off the accumulated dirt, debris, and other contaminants off of the filter elements. The dirt and debris located at the top of the filter elements, however, may accumulate and may not be effectively cleaned by the compressed air self cleaning.

There is thus a need for an improved inlet air filter having an extended useful life.

### BRIEF SUMMARY OF THE INVENTION

In an exemplary embodiment, an air filter includes a filter material having a plurality of pleats, where each of the pleats includes a primary section and a folded section. The folded section is initially folded over at least a portion of the primary section such that the pleat has an initial pleat height. The folded section is configured to unfurl from being folded over the primary section based on a pressure differential between opposite sides of the filter material.

In another exemplary embodiment, an air filter includes a filter material with a plurality of pleats, where each of the pleats includes a primary section and a folded section. The pleats are operationally configurable between a folded position in which the folded section is folded over at least a portion of the primary section, and an unfurled position in which the folded section is unfurled from being folded over the primary section based on a pressure differential between opposite sides of the filter material.

In yet another exemplary embodiment, a method of extending a useful life of a filter includes the steps of flowing air across the filter material, where the filter material filters contaminants from the air, and when a predetermined pressure differential is reached between opposite sides of the filter material, the pressure differential automatically unfurling the folded section from being folded over the primary section to increase a flow area of the filter material.

### BRIEF DESCRIPTION OF THE DRAWINGS

FIG. 1 is a front cross section through a pleated air filter;

FIG. 2 is a side cross section showing air flow through the air filter;

FIG. 3 is a detailed view of the filter material pleats according to preferred embodiments; and

FIG. 4 is a side view showing the filter media and end membrane.

### DETAILED DESCRIPTION OF THE INVENTION

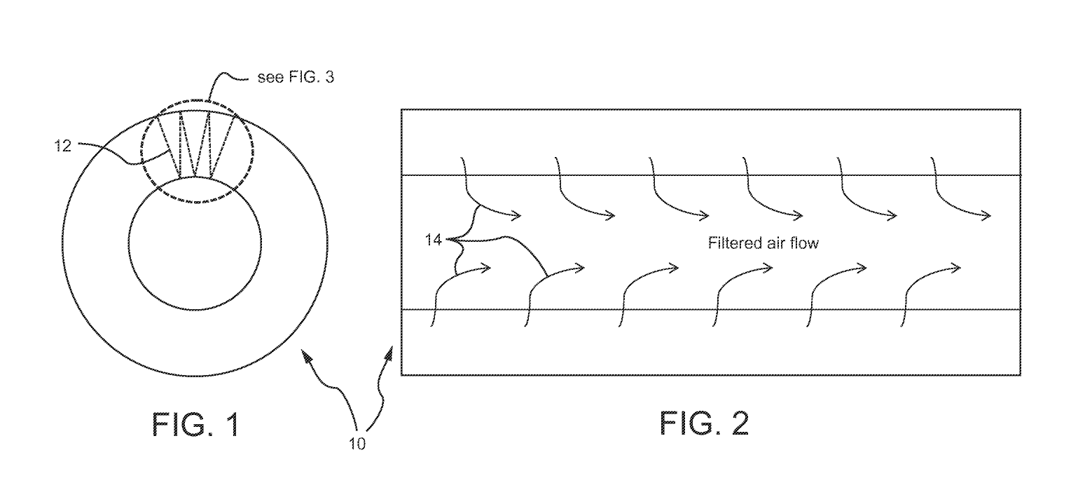

With reference to FIGS. 1 and 2, a filter media 10 may be formed with a suitable filter material including a plurality of pleats 12. The pleats 12 serve to expand a surface area of the filter material and maximize the effectiveness of the air filter 10. In an exemplary application, with reference to FIG. 2, air flowing radially through the filter 10 is filtered by the filter material to remove contaminants, and the filtered air is directed axially (see arrows 14 in FIG. 2) out of the filter 10 to a compressor or other downstream part of the turbine.

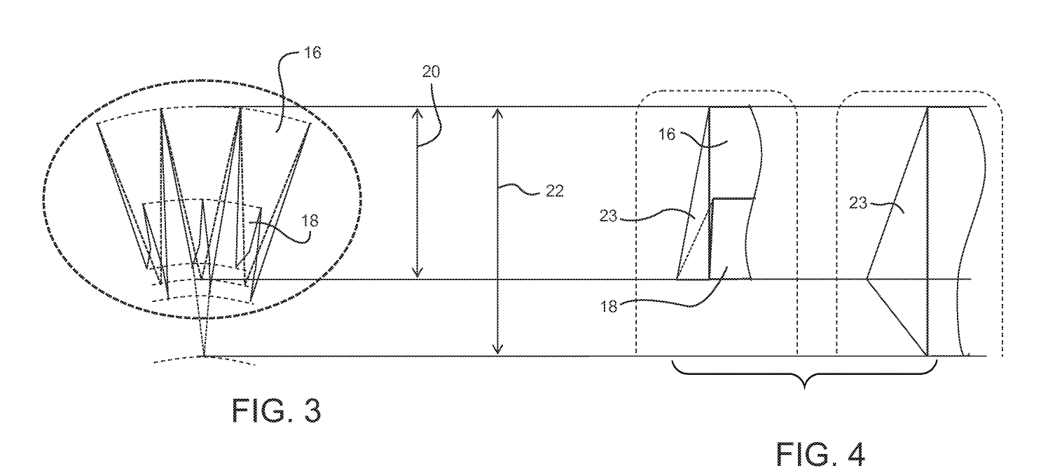

Conventional air filters clog over time, and power plant production can go down in proportion with the loss of air flow. In order to extend a useful life of the filter, with reference to FIGS. 3 and 4, each of the pleats in the filter material includes a primary section 16 and one or more folded sections 18. As shown, the folded section 18 is initially folded over at least a portion of the primary section. This orientation defines an initial pleat height 20. As the filter continues to filter contaminants from the air, a pressure differential between opposite sides of the filter material increases.

When the pressure differential reaches a predetermined value, the folded section 18 is configured to unfurl from being folded over the primary section 16 to thereby increase the flow area and maintain the pressure differential at acceptable levels. The pleats 12 are thus operationally configurable between a folded position in which the folded section 18 is folded over at least a portion of the primary section 16, and an unfurled position in which the folded section 18 is unfurled from being folded over the primary section 16 based on a pressure differential between opposite sides of the filter material.

That is, when a predetermined pressure differential is reached between opposite sides of the filter material, the pressure differential automatically unfurls the folded section 18 from being folded over the primary section 16 to increase the flow area of the filter material. Thus, as the pressure drop is increased across the filter material with the contaminants in the filter material, once the pressure drop exceeds the predetermined pressure differential, the pressure drop is then reduced by the unfurling of the folded section 18.

When the folded section 18 is unfurled from being folded over the primary section 16, the pleat comprises an unfurled height 22, which as shown is larger than the initial pleat height 20. In a preferred embodiment, the unfurled height 22 is about 20% greater than the initial pleat height 20. In this context, the increased flow area when the folded section 18 is unfurled from being folded over the primary section 16 is about 20% greater.

Pleat ends are preferably formed of a folded flexible rubber membrane 23 to accommodate the pleat fold (see FIG. 4). The folded membrane 23 is dimensionally matched to the unfurled height 22.

The air filter according to preferred embodiments allows for longer time periods between air filter changes without incurring a performance penalty. As a consequence, scheduled maintenance interruptions can be reduced, and power plant performance is more efficient.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An air filter comprising a filter material including a plurality of pleats, wherein each of the pleats includes a primary section and a folded section, the folded section being initially folded over at least a portion of the primary section such that the pleat has an initial pleat height, wherein the folded section is configured to unfurl from being folded over the primary section based on a pressure differential between opposite sides of the filter material.

2. An air filter according to claim 1, wherein the pleat comprises an unfurled height, larger than the initial pleat height, when the folded section is unfurled from being folded over the primary section.

3. An air filter according to claim 2, wherein the unfurled height is about 20% greater than the initial pleat height.

4. An air filter according to claim 2, wherein distal ends of the pleats comprise a folded membrane.

5. An air filter according to claim 4, wherein the folded membrane is dimensionally matched to the unfurled height.

6. An air filter according to claim 4, wherein the membrane is rubber.

7. An air filter according to claim 1, comprising an increased flow area when the folded section is unfurled from being folded over the primary section.

8. An air filter according to claim 7, wherein the increased flow area comprises an increase of about 20%.

9. An air filter comprising a filter material including a plurality of pleats, wherein each of the pleats includes a primary section and a folded section, the pleats being operationally configurable between a folded position in which the folded section is folded over at least a portion of the primary section, and an unfurled position in which the folded section is unfurled from being folded over the primary section based on a pressure differential between opposite sides of the filter material.

10. An air filter according to claim 9, wherein the pleat comprises an initial pleat height and an unfurled height larger than the initial pleat height, and wherein the unfurled height is about 20% greater than the initial pleat height.

11. An air filter according to claim 9, comprising an increased flow area in the unfurled position.

12. An air filter according to claim 11, wherein the increased flow area comprises an increase of about 20%.

13. A method of extending a useful life of a filter, the filter including a filter material with a plurality of pleats, wherein each of the pleats includes a primary section and a folded section, the folded section being initially folded over at least a portion of the primary section, the method comprising:
flowing air across the filter material, the filter material filtering contaminants from the air; and
when a predetermined pressure differential is reached between opposite sides of the filter material, the pressure differential automatically unfurling the folded section from being folded over the primary section to increase a flow area of the filter material.

14. A method according to claim 13, comprising increasing a pressure drop across the filter material with the contaminants in the filter material until the pressure drop exceeds the predetermined pressure differential, then reducing the pressure drop by the unfurling of the folded section.
